(19) United States
(12) Patent Application Publication
(10) Pub. No.: US 2011/0144824 A1
(43) Pub. Date: Jun. 16, 2011

(54) POWER CONSERVING AC POWER OUTLET ON A COMPUTER

(76) Inventors: Robert Campesi, San Jose, CA (US); Benjamin Abraham, Cupertino, CA (US)

(21) Appl. No.: 13/058,194

(22) PCT Filed: Aug. 12, 2008
(86) PCT No.: PCT/US2008/072890

§ 371 Date: Feb. 8, 2011

(51) Int. Cl. G05D 7/06

(52) U.S. Cl. 700/297

(57) ABSTRACT

An apparatus for providing a power conserving AC power outlet in a computer. An embodiment includes a computer, power input, power supply, AC power outlet, switch and control circuit. The power input provides AC input power to computer. The power supply is connected to the power input and provides power to components of computer. External AC-powered devices may be plugged into AC power outlet. The switch is connected to the AC power outlet and power input. The switch connects the AC power outlet to the power input when the switch is closed and disconnects AC power outlet from power input when the switch is opened. The control circuit is connected to the switch and the power input. The control circuit reads, for example, current drawn by the power supply on the power input and opens the control circuit when the current falls below a threshold.

### BACKGROUND

With rising energy costs, more attention is being paid to the power usage of computers and computer peripherals. While personal computers today do have a sleep, standby and/or hibernate (“S3”) mode that they will enter if idle for a sufficient period of time, or which a user may select to enter, and which reduces the computer's power usage, most peripherals do not have such a mode and will typically remain fully powered when the computer enters S3 mode. Even for those peripherals that do have an S3 mode, power is still drawn by the peripherals when in S3 mode.

Old personal computer power supplies had a convenience outlet. A convenience outlet was an outlet, typically on the back of the computer that a user could plug computer peripherals into, such as a monitor or printer. However, the convenience outlet only shut off power to a peripheral when the computer was shut off. The convenience outlet did not shut off peripherals when the computer went into a S3 mode. Eventually, convenience outlets were dropped as a feature from personal computers.

### SUMMARY

An advantage of the embodiments described herein is that they overcome the disadvantages of the prior art. These advantages and others are achieved by an apparatus for providing a power conserving AC power outlet in a computer. The apparatus includes a computer, a power input, a power supply, an AC power outlet, a switch and a control circuit. The power input provides AC input power to the computer. The power supply is connected to the power input and provides power to components of the computer. External AC-powered devices may be plugged into the AC power outlet. The switch is connected to the AC power outlet and the power input. The switch connects the AC power outlet to the power input when the switch is closed and disconnects the AC power outlet from the power input when the switch is opened. The control circuit is connected to the switch and the power input. The control circuit reads a level of current drawn by the power supply on the power input and opens the control circuit when the current level falls below a threshold.

These advantages and others are also achieved by an apparatus for providing a power conserving AC power outlet in a personal computer. The apparatus includes a computer, a power input, a power supply, an AC power outlet, a switch and a control circuit. The power input provides AC input power to the computer. The power supply is connected to the power input and provides power to components of the computer. External AC-powered devices may be plugged into the AC power outlet. The switch is connected to the AC power outlet and the power input. The switch connects the AC power outlet to the power input when the switch is closed and disconnects AC power outlet from the power input when the switch is opened. The control circuit is connected to the switch and the power input. The control circuit opens the switch when the computer enters a hibernate, sleep or shut-down mode.

These advantages and others are provided by a method of using a power conserving AC power outlet in a computer. The method includes connecting peripheral devices to a power conserving AC power outlet in a computer, supplying power to the AC power outlet, thereby powering the peripheral devices connected to the AC power outlet, measuring current drawn by the computer, and de-powering the AC power outlet when the current drawn by the computer falls below a threshold, thereby cutting off power to the peripheral devices.

These advantages and others are provided by an apparatus for providing a power conserving AC power outlet in a computer. The computer includes a memory. The apparatus also includes a power input that provides AC input power to the computer, a power supply that is connected to the power input and that provides power to components of computer, a AC power outlet in the computer to which external AC-powered devices may be plugged, a switch connected to the AC power outlet and power input, and a software routine, loaded, into the memory, that generates a signal that opens the switch when the computer enters a hibernate, sleep or shut-down mode and closes the switch when the computer powers-on. The switch connects the AC power outlet to the power input when the switch is closed and disconnects AC power outlet from the power input when the switch is opened.

### DESCRIPTION OF THE DRAWINGS

The detailed description will refer to the following drawings, wherein like numerals refer to like elements, and wherein:

FIG. 1 illustrates an embodiment of an apparatus for providing a power conserving AC power outlet in a computer.

FIG. 2 illustrates an embodiment of an apparatus for providing a power conserving AC power outlet in a computer.

FIG. 3 illustrates an embodiment of a method utilizing an apparatus for providing a power conserving AC power outlet in a computer.

FIG. 4 illustrates an embodiment of an apparatus for providing a power conserving AC power outlet in a computer.

FIG. 5 illustrates an embodiment of an apparatus for providing a power conserving AC power outlet in a computer.

### DETAILED DESCRIPTION

An apparatus for providing a power conserving AC power outlet in a computer (“PC”) is described herein. Embodiments of the apparatus provide a convenience outlet built into a PC that will shut off the power to peripherals plugged into it when the PC enters sleep (standby), hibernate or shutdown mode (S3, S4, S5). In the embodiments, when the PC's power consumption goes below a set-up threshold, the power to the controlled outlet will be cut off. The controlled outlet can be built inside the PC power supply or built inside the PC chassis. It should be noted that the computers (PC or otherwise) described herein may be a desktop, laptop, Windows CE™ device (such as a Media Center), Apple iTV™ or other processor-driven device. The computers described herein may be home or residential computers, work computers, government computers or computers in any field. The computers described herein may be driven by any processor and support any OS (including Apple™, Windows™, etc.).

As mentioned above, when the computer is in sleep, hibernate, or shutdown (OFF) modes, the peripheral devices are still consuming power (e.g., monitor, printer, USB hub, powered speakers, desk lamp, radio, fan, etc.). Embodiments of the controlled outlet will automatically shut off the power to these devices. A power strip can be plugged into the controlled outlet so that all the devices in the workspace can be so controlled.

A PC with a built-in power conserving AC power outlet, according to the embodiments described herein, enables a user to plug a peripheral device which he wants to turn off when the computer is not running (i.e., the PC is in sleep, hibernate or OFF modes). Embodiments described herein use a circuit to measure the current going into or drawn by the PC. If this current falls below a set threshold, the circuit will turn off an electronic switch and cut off the AC power to the power conserving AC power outlet. This solution enables the user to save power and cost by shutting off peripheral devices when the PC is not in working mode. When the PC goes to sleep, hibernates or turns off, any peripheral device plugged into the controlled outlet will consume zero power.

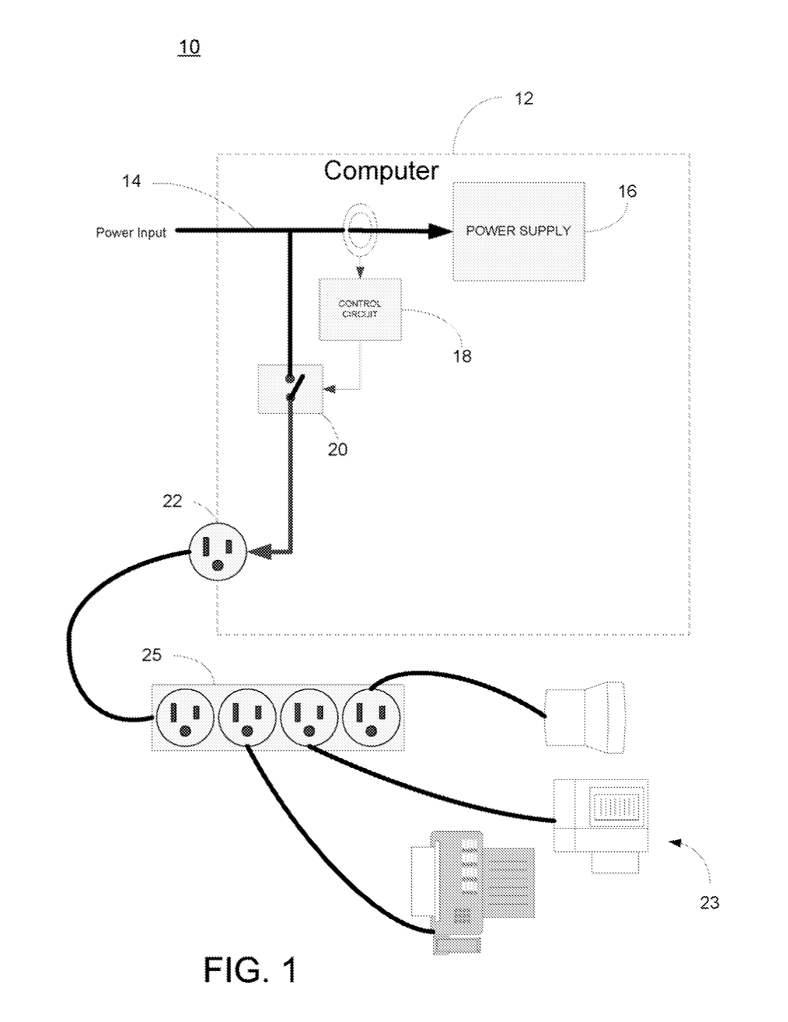

With reference now to FIG. 1, shown is an embodiment of an apparatus 10 for providing a power conserving AC power outlet in a computer. Apparatus 10 includes computer 12 in which power conserving AC power outlet 22 is provided. Power input 14 receives power typically from wall power supply outlet via computer power cord (not shown). AC power is carried from power input 14 to power supply 16 of computer 12. Power supply 16 provides DC power for computer components.

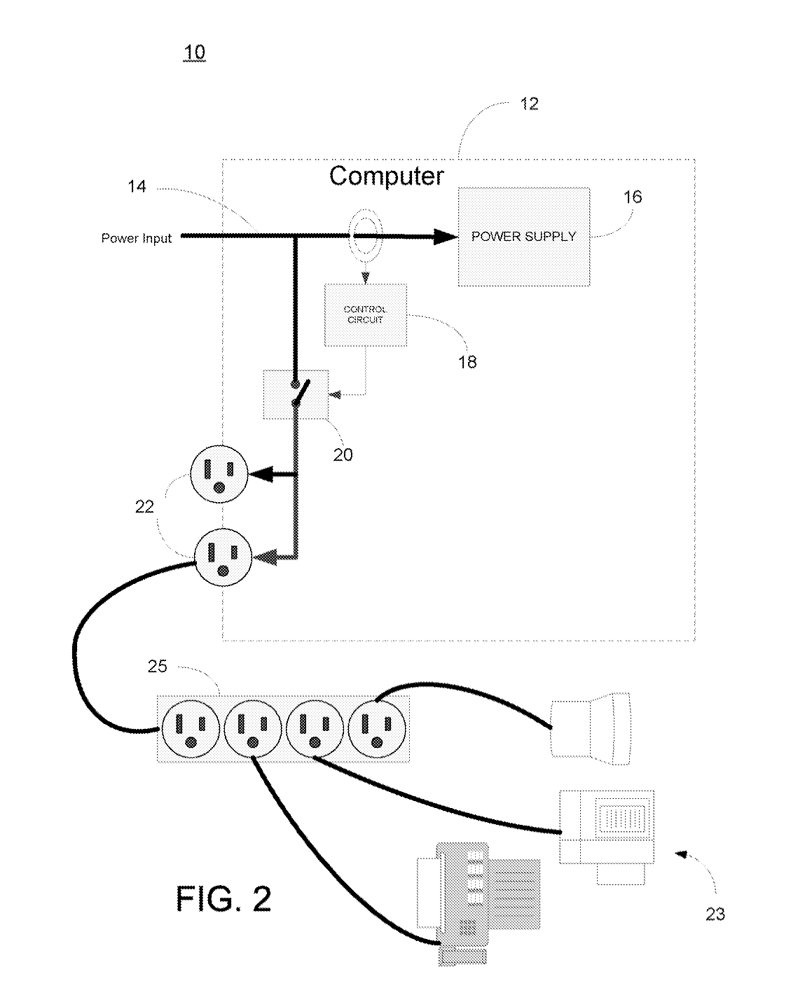

As is shown in FIG. 1, a line from power input 14 also runs to power conserving AC power outlet 22. As illustrated here, power outlet 22 is situated on external chassis of computer 12 no that a user can plug peripherals (e.g., monitor, printer, etc.) 23 into power outlet 22. Line from power input 14 is preferably of sufficient rating and carrying capacity so that user could plug multiple peripherals into power outlet 22, i.e., via a power strip 25 plugged into power outlet 22. Although power outlet 22 is shown situated on external chassis of computer 12 it could be situated elsewhere, such as internally behind an access door in computer chassis. Likewise, although controlled power outlet 22 is shown as an AC power outlet, in embodiments outlet 22 could be a DC power outlet (rectifier to rectify AC power to DC or other AC/DC converter on power input 14 would be provided) or an additional power conserving DC power outlet could be provided. Moreover, although embodiment illustrated only shows one power conserving outlet 22, multiple power conserving outlets 22 (e.g., AC, DC or both) could be provided. FIG. 2 illustrates such an embodiment. In another embodiment, apparatus 10 could include one or more power outlets that are not controlled (not connected to the switch 20). Consequently, if there were peripherals that should remain on even if computer 12 sleeping, hibernating or shut-down, those peripherals could be plugged into such an outlet.

On line from power input 14 to controlled outlet 22 a switch 20 is provided. Switch 20 controls supply of power to controlled outlet 22, closing to allow power through to outlet 22 and opening to break circuit and prevent power from reaching outlet 22. Control circuit 18 operates switch 20. Control circuit 18 is connected to power input 14, specifically line from power input 14 to power supply 16. Control circuit 18 reads current on power input 14 (in alternative embodiments, control circuit 18 could read power drawn over power input 14). The current on power input 14 read by control circuit 18 is the current drawn by power supply 16 and is indicative of how much wattage power supply 16, and hence computer 12, are using. When computer 12 is fully powered on and is not in S3, S4 or S5 modes, this current will be above a certain threshold level. The threshold level will generally be set during the design or manufacturing so that it can be changes for different SKUs or as technology changes. On a current typical desktop, a typical threshold, expressed in watts, would be 7 to 10 W (current would be derived using the input voltage−VI=P). Typical S3 to S5 states are 1 to 5 W and a computer on or in active S0, S1 and S2 states is at 30 W or more. As soon as the computer sleeps, hibernates or shuts-down (i.e., as soon as computer enters S3, S4 or S5 modes), the current on power input 14 will drop below the threshold level. When the current on power input 14 drops below the threshold, control circuit 18 opens switch 20, cutting off power from controlled outlet 22. When current on power input 14 reaches or exceeds threshold level, control circuit 18 closes switch 20, providing power to controlled outlet 22.

In a typical embodiment, current threshold is factory-installed into control circuit 18. In other words, current threshold is pre-set before control circuit 18 is placed into computer 12. In other embodiments, threshold may be adjusted via software running on computer 12 or other mechanisms. Likewise, embodiments could include software that could be used to set a delay in opening of switch 20 by control circuit 18 in order to enable peripherals 23 that are finishing a task (e.g., printing a document) that may be completed after computer has gone into S3, S4 or S5 mode. Alternatively, embodiments could be hard-wired or pre-set with such a delay (e.g., control circuit 18 could include a capacitive charge that takes, e.g., 15-seconds to discharge and must discharge before control circuit 18 opens switch 20.

When peripherals 23 are plugged into controlled outlets 22 illustrated here, power consumption is reduced. Anytime a computer goes to sleep, hibernates or shuts-down, the peripherals will be shut-down as well. Accordingly, peripherals 23 will not continue to draw power while computer is in state that it would not make use of peripherals 23.

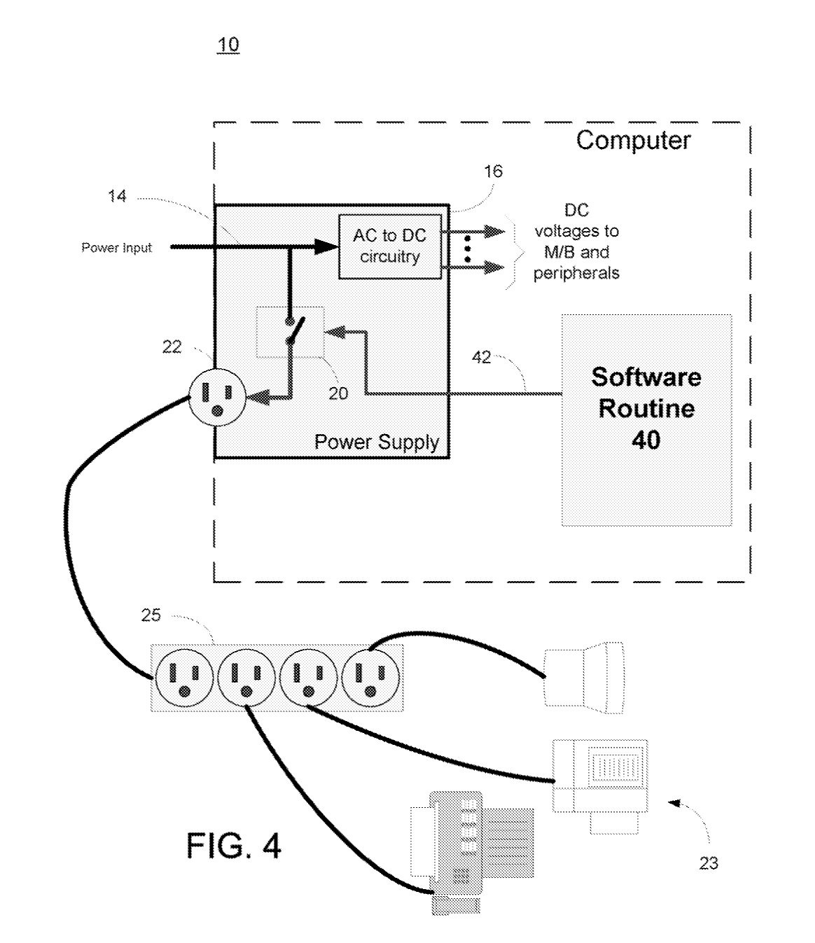

In an embodiment, as shown in FIG. 1, control circuit 18 and controlled outlet 22 are located inside computer 12 (e.g., on a dedicated circuit board or on the motherboard of computer 12). In another embodiment, as shown in FIG. 1, control circuit 18 and controlled outlet 22 are located inside power supply 16. Power supply 16 is typically located inside computer 12, but power supply 16 may be external to computer 12. The location of control circuit 18 and controlled outlet 22 in the embodiments shown in FIGS. 1 and 4 may be swapped.

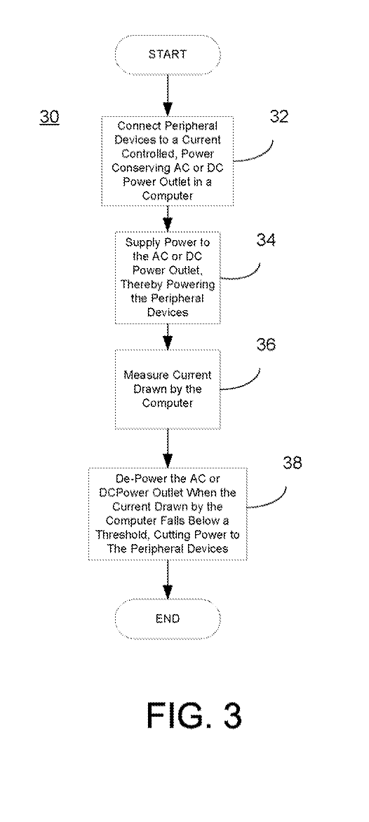

With reference now to FIG. 3, shown is a flowchart illustrating an embodiment of a method 30 for using a power conserving AC power outlet in a computer. Peripheral devices are connected to a power conserving AC power outlet in a computer, block 32. Power is supplied to the AC power outlet, powering the peripheral devices connected thereto, block 34. Current drawn by the computer is measured, block 36. When the current drawn by the computer falls below a threshold, e.g., because the computer goes into S3, S4 or S5 modes, the AC power outlet is de-powered, cutting off power to the peripheral devices, block 38.

Wither reference now to FIG. 4, shown is another embodiment of an apparatus 10 for providing a power conserving AC power outlet in a computer. Apparatus 10 includes computer 12 in which controlled AC power outlet 22 is provided. Power input 14 receives power typically from wall power supply outlet via computer power cord (not shown). AC power is carried from power input 14 to power supply 16 of computer 12. Power supply 16 provides DC power for computer components.

As above, a line from power input 14 also runs to controlled AC power outlet 22 through switch 20. Power outlet 22 is situated on external chassis of computer 12 so that a user can plug peripherals (e.g., monitor, printer, etc.) 23 into power outlet 22. Line from power input 14 is preferably of sufficient rating and carrying capacity so that user could plug multiple peripherals 23 into power outlet 22, i.e., via a power strip 25 plugged into power outlet 22. Although power outlet 22 is shown situated on external chassis of computer 12 it could be situated elsewhere, such as internally behind an access door in computer chassis. Likewise, although controlled power outlet 22 is shown as an AC power outlet, in embodiments outlet 22 could be a DC power outlet (rectifier to rectify AC power to DC or other AC/DC converter on power input 14 would be provided) or an additional controlled DC power outlet could be provided. Moreover, although embodiment illustrated only shows one controlled outlet 22, multiple controlled outlets 22 (e.g., AC, DC or both) could be provided. In another embodiment, apparatus 10 could include one or more power outlets that are not controlled (not connected to the switch 20). Consequently, if there were peripherals 23 that should remain on even if computer 12 sleeping, hibernating or shut-down, those peripherals could be plugged into such an outlet. On line from power input 14 to controlled outlet 22 a switch 20 is provided. Switch 20 controls supply of power to controlled outlet 22, closing to allow power through to outlet 22 and opening to break circuit and prevent power from reaching outlet 22.

With continuing reference to FIG. 4, instead of a control circuit as shown above, the embodiment shown includes a power outlet software or BIOS routine 40 that controls switch 20. Routine 40 may be loaded into the computer ROM, PROM, EPROM, FLASH, or any other type of non-volatile memory, or may be loaded into RAM as part of an operating system, driver or other program. Routine 40 turns power OFF to power outlet 22 (e.g. opens switch 20) at end of standby, hibernate or shut-down routines. In other words, power outlet routine 40 detects when computer's operating system completes standby, hibernate, shut-down or similar routines and opens switch 20. Routine 40 turns power ON to power outlet 22 (e.g., closes switch 20) at computer power ON routine. In other words, power outlet routine 40 detects when computer is powered on, either from standby state, hibernation or shut-down, and closes switch 20 (in an alternative embodiment, routine 40 may wait until operating system starts or completes its start-up to closes switch 20. Power outlet routine 40 typically controls switch 20 (i.e., signals switch 20 to open or close) with a computer program-controlled signal 42 transmitted over a connection or line to the switch.

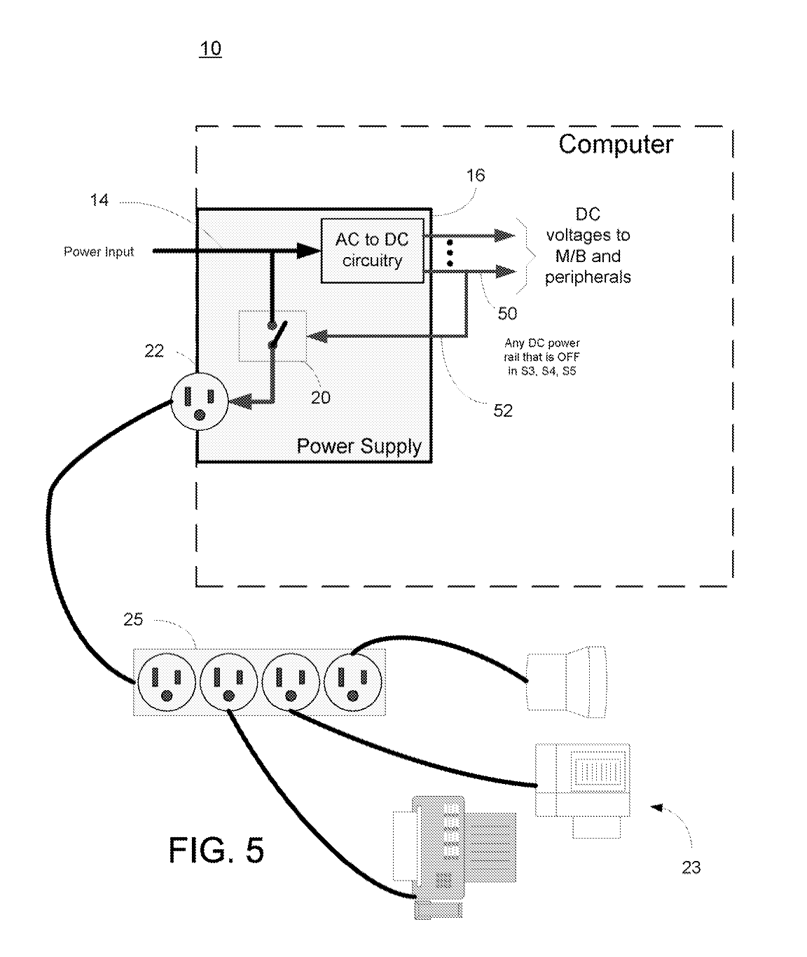

When a computer enters a S3, S4, or S5 state, the 12V, 5V DC power rails get shut off. Consequently, in an embodiment, the 12V, 5V DC power rails may be used to turn off the controlled outlet(s). With reference now to FIG. 5, shown is such an embodiment of an apparatus 10 for providing a power conserving AC power outlet in a computer. In the embodiment shown, line 52 from a 12V or 5V DC power rail 50 that is OFF in S3, S4 and S5 modes controls switch 20. When power rail 50 is on, line 52 provides power to switch 20, keeping switch 20 closed and power supplied to power outlet 22. When power rail 50 is shut-off, line 52 ceases to provide power to switch 20, causing switch 20 to open and cutting off power to power outlet 22. In an embodiment, switch 20 may be directly connected to power rail 50.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. An apparatus for providing a power conserving AC power outlet in a computer, comprising:
a computer;
a power input, wherein the power input provides AC input power to the computer;
a power supply connected to the power input, wherein the power supply provides power to components of computer;
a AC power outlet in the computer, wherein external AC-powered devices may be plugged into the AC power outlet;
a switch connected to the AC power outlet and the power input, wherein the switch connects the AC power outlet to the power input when the switch is closed and disconnects AC power outlet from the power input when the switch is opened; and
a control circuit connected to the switch and the power input, wherein the control circuit reads the level of current drawn by the power supply on the power input and opens the switch when the current level falls below a threshold.

2. The apparatus of claim 1 wherein the threshold is indicative of a current below which the computer has entered a sleep, hibernate or shut-down mode.

3. The apparatus of claim 1 wherein the threshold is pre-set in the control circuit.

4. The apparatus of claim 1 comprising a plurality of AC power outlets wherein the switch connects the plurality of AC power outlets to the power input when the switch is closed and disconnects the plurality of AC power outlets from the power input when the switch is opened.

5. The apparatus of claim 1 further comprising a DC power outlet, wherein power supplied to the DC power outlet is controlled by the control circuit such that current below the threshold causes power to the DC power outlet to be shut-off.

6. The apparatus of claim 1 wherein the AC power outlet is positioned on an exterior surface of the computer.

7. The apparatus of claim 1 wherein the computer is a Windows CE device.

8. The apparatus of claim 1 wherein the control circuit and controlled outlet are located inside the computer.

9. The apparatus of claim 1 wherein the control circuit and controlled outlet are located inside the power supply.

10. An apparatus for providing a power conserving AC power outlet a computer, comprising:
a computer;
a power input, wherein the power input provides AC input power to the computer;
a power supply connected to the power input, wherein the power supply provides power to components of computer;
a AC power outlet in the computer, wherein external AC-powered devices may be plugged into the AC power outlet;
a switch connected to the AC power outlet and power input, wherein the switch connects the AC power outlet to the power input when the switch is closed and disconnects AC power outlet from the power input when the switch is opened; and
a control circuit connected to the switch and the power input, wherein the control circuit opens the switch when the computer enters a hibernate, sleep or shut-down mode.

11. The apparatus of claim 10 comprising a plurality of AC power outlets wherein the switch connects the plurality of AC power outlets to the power input when the switch is closed and disconnects the plurality of AC power outlets from power input when the switch is opened.

12. The apparatus of claim 10 further comprising a DC power outlet, wherein power supplied to the DC power outlet is controlled by the control circuit such that the computer entering a hibernate, sleep or shut-down mode causes power to the DC power outlet to be shut-off.

13. The apparatus of claim 10 wherein the AC power outlet is positioned on an exterior surface of the computer.

14. The apparatus of claim 10 wherein the computer is a Windows CE device.

15. The apparatus of claim 10 wherein the control circuit and controlled outlet are located inside the computer.

16. The apparatus of claim 10 wherein the control circuit and controlled outlet are located inside the power supply.

17. A method of using a power conserving AC power outlet in a computer, comprising:
connecting peripheral devices to a power conserving AC power outlet in a computer;
supplying power to the AC power outlet, thereby powering the peripheral devices connected to the AC power outlet;
measuring current drawn by the computer; and
de-powering the AC power outlet when the current drawn by the computer fails below a threshold, thereby cutting off power to the peripheral devices.

18. The method of claim 17, wherein the threshold indicates the level below which the computer has entered a hibernate, sleep or shut-down mode.

19. An apparatus for providing a power conserving AC power outlet in a computer, comprising:
a computer that includes a memory;
a power input, wherein the power input provides AC input power to the computer;
a power supply connected to the power input, wherein the power supply provides power to components of computer;
a AC power outlet in the computer, wherein external AC-powered devices may be plugged into the AC power outlet;
a switch connected to the AC power outlet and power input, wherein the switch connects the AC power outlet to the power input when the switch is closed and disconnects AC power outlet from the power input when the switch is opened; and
a routine loaded into the memory, wherein the routine generates a signal that opens the switch when the computer enters a hibernate, sleep or shut-down mode and closes the switch when the computer powers-on.

20. The apparatus of claim 19 comprising a plurality of AC power outlets wherein the switch connects the plurality of AC power outlets to the power input when the switch is closed and disconnects the plurality of AC power outlets from power input when the switch is opened.

21. The apparatus of claim 19 in which the routine is a software routine loaded into RAM.

22. The apparatus of claim 19 in which the routine is a BIOS routine loaded into non volatile memory.

23. An apparatus for providing a power conserving AC power outlet a computer, comprising:
a computer that includes a memory;
a power input, wherein the power input provides AC input power to the computer;
a power supply connected to the power input, wherein the power supply provides power to components of computer;
a AC power outlet in the computer, wherein external AC-powered devices may be plugged into the AC power outlet;
a switch connected to the AC power outlet and power input, wherein the switch connects the AC power outlet to the power input when the switch is closed and disconnects AC power outlet from the power input when the switch is opened; and
a DC power rail connected to the power supply, wherein the DC power rail is shut-off when the computer enters a hibernate, sleep or shut-down mode and the switch is connected to the DC power rail so that the switch opens when the DC power rail is shut off.
